(19) United States
(12) Patent Application Publication
(10) Pub. No.: US 2010/0182730 A1
(43) Pub. Date: Jul. 22, 2010

(54) FERROELECTRIC VARACTOR WITH IMPROVED TUNING RANGE

(75) Inventors: Danielle Beelen, Nederweert (NL); Mareike Klee, Straelen (DE); Klaus Reimann, Eindhoven (NL); Wilhelmus C. Keur, Weert (NL); Rüdiger Mauczok, Erkelenz (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/447,078

(22) PCT Filed: Oct. 19, 2007
(86) PCT No.: PCT/IB2007/054260

§ 371 Date: Apr. 24, 2009

(30) Foreign Application Priority Data
Oct. 25, 2006 (EP) 06122895.3

(51) Int. Cl. H01G 7/06; H01G 7/00

(52) U.S. Cl. 361/281; 427/80

(57) ABSTRACT

The present invention relates to a ferroelectric varactor (400) that comprises a dielectric-layer stack (408) between electrodes (406, 410). The dielectric-layer stack comprises an alternating layer sequence of at least three dielectric layers. At cc least two first dielectric layers of the dielectric-layer stack are made of a non-single-crystalline first dielectric material having a first dielectric constant, at least one second dielectric layer of the dielectric-layer stack is made of a non-single-crystalline second dielectric material with a second dielectric constant that differs from the first dielectric constant. One of the first and second dielectric materials exhibits a weaker ferroelectric hysteresis. The dielectric material with the weaker ferroelectric hysteresis makes up more than 20% of the total volume of the dielectric-layer stack. The ferroelectric varactor of the present invention achieves high relative dielectric permittivities in the dielectric layers, a high breakdown voltage, a large tuning range at low voltages, and low dielectric losses.

### FIELD OF THE INVENTION

The present invention relates to a ferroelectric varactor, an electronic component comprising a ferroelectric varactor, and to a method for fabricating a ferroelectric varactor.

### BACKGROUND OF THE INVENTION

A varactor is a tunable dielectric capacitor. It exhibits a change of the capacitance when a direct-current (DC) voltage is applied to its electrodes.

Tunable MIM capacitors with ferroelectric or paraelectric dielectric materials exhibit a high relative dielectric permittivity ∈ᵣ and a strong dependence of the relative permittivity ∈ᵣ on the DC voltage. The tunability T may be defined as a fractional change of the relative dielectric permittivity ∈,

$$T ( V ) = \frac{{ɛ}_{r} ( 0 ) - {ɛ}_{r} ( V )}{{ɛ}_{r} ( 0 )} ,$$

wherein V indicates a voltage applied between the two electrodes of the capacitor.

US 2006/0118843 A1 describes a thin dielectric film for use in a ferroelectric varactor. In order to reduce a lattice mismatch between a single-crystal MgO substrate, a paraelectric seed layer is epitaxially grown before epitaxial growth of a ferroelectric BaₓSr₁₋ₓTiO₃ (BST) film on the paraelectric seed layer. The paraelectric seed layer reduces a discrepancy in a lattice constant between the substrate and the ferroelectric BST film, so as to reduce strain and mechanical stress inside the BST film. This way, dielectric properties of the BST film can be realized, which approach those of a BST single crystal, for which a high tuning rate of the relative dielectric permittivity and a low dielectric loss is characteristic. The seed layer is described to have a thickness of between several 0.1 nm to several 10 nm. The thickness of the BST layer is described to be between 0.1 and 1 μm.

It is a disadvantage of the dielectric film structure of US 2006/0118843 A1 that in order to achieve a high tuning rate of the dielectric constant and a low dielectric loss, that is, good high frequency characteristics, a specific layer sequence is required. This limits the flexibility in the design of the ferroelectric varactor.

### SUMMARY OF THE INVENTION

According to a first aspect of the invention a ferroelectric varactor is provided that comprises a first and a second electrically conductive electrode and a dielectric-layer stack between the electrodes. In the ferroelectric varactor of the invention, the dielectric layer stack comprises an alternating layer sequence of at least three dielectric layers in a series connection.

At least two non-single-crystalline first dielectric layers of the dielectric-layer stack are made of a first dielectric material that has a first dielectric constant. At least one non-single-crystalline second dielectric layer of the dielectric-layer stack is arranged between two respective first dielectric layers and made of a second dielectric material with a second dielectric constant that differs from the first dielectric constant.

One of the first and second materials, when hypothetically arranged between two test electrodes, exhibits a stronger ferroelectric hysteresis of its polarization under an alternating voltage applied between the electrodes than the other of the first and second dielectric materials. This is related to the respective materials as such, that is, it can be observed for instance in a hypothetical test capacitor, which contains only the respective material as a dielectric layer between the test electrodes. Note that this refers to a hypothetical capacitor structure. Such a hypothetical test capacitor differs from the ferroelectric varactor of the invention, for instance in that it only contains one dielectric material layer. Ferroelectric hysteresis is typically represented by a plot of the polarization (in units of C/m²) as a function of an applied alternating voltage (in units of V). A “stronger” or “weaker” hysteresis refers to the amount of the coercive field and of the remnant polarization. The higher the amount of remnant polarization and coercive field, the stronger is the hysteresis.

Furthermore, in the ferroelectric varactor of the first aspect of the invention, the extensions of the individual first and second dielectric layers of the dielectric-layer stack in a direction perpendicular to their respective layer planes are suitably chosen such that the dielectric material with the weaker ferroelectric hysteresis makes up more than 20% of the total volume of the dielectric-layer stack. The extension of a layer in a direction perpendicular to its layer plane is also referred to as its thickness. The layer plane is a hypothetical plane that extends in lateral directions of a layer, i.e., perpendicular to a main growth direction of the layer during its fabrication. Where growth is performed on a substrate, the layer plane is parallel to a substrate surface prior to growth of the layer. Here, the substrate surface is assumed to be perfectly flat for the purpose of the present definition.

In the ferroelectric varactor of the invention the dielectric layer stack as a whole has an either reduced or fully suppressed ferroelectric hysteresis of its polarization under an alternating voltage applied between the first and second electrode, in comparison with a dielectric layer that is made only from the dielectric material that exhibits the stronger ferroelectric hysteresis and has a identical volume as the dielectric-layer stack. This allows a higher relative dielectric permittivity and a higher tuning range than with a single-dielectric-layer configuration.

While the use of non-single-crystalline dielectric materials in the first and second dielectric layers of the dielectric-layer stack tends to reduce the tunability, this undesired effect is compensated in the ferroelectric varactor of the invention by having different dielectric-permittivity values in the first and second dielectric layers. Use of one material with a suitably higher dielectric permittivity than that of the other material can compensate the loss of tunability.

On the other hand, one of the two dielectric materials, typically the material with the higher dielectric permittivity, exhibits a stronger ferroelectric hysteresis of its polarization under an alternating voltage. However, in the ferroelectric varactor of the invention this disadvantageous property, which would create dielectric losses in a prior-art device structure, is compensated by including the other dielectric material that has a weaker ferroelectric hysteresis. By providing the material with a weaker ferroelectric hysteresis in a volume fraction of more than 20%, and, in typical embodiments, less than 95% of the dielectric-layer stack, the compensation of the ferroelectric hysteresis is strong enough to reduce or fully avoid dielectric loss due to ferroelectric hysteresis. Dielectric loss is a partial transformation of the energy of an applied alternating electric field caused by the interaction of the field with the dielectric material. It eventually produces a rise in temperature of the dielectric material that is exposed to the alternating electric field. Such a temperature rise can cause damage to the capacitor and requires appropriate cooling, which is expensive.

Non-single-crystalline dielectric layers do not require a specific strain engineering that provides a lattice-constant sequence in the layers for enabling an epitaxial growth. In comparison with the structure of US 2006/0118843 A1, therefore, the ferroelectric varactor of the first aspect of the present invention has relaxed requirements regarding the order of the layer sequence. This provides an increased freedom in the design of the layer structure of the dielectric-layer stack.

Furthermore, non-single-crystalline dielectric layers in the dielectric-layer stack of the ferroelectric varactor of the present invention enable a high relative permitivity and large tuning range and, in preferred embodiments, a high breakdown field on non-single crystal surfaces such as amorphous or polycrystalline oxidic layers, e.g., TiO₂, SiO₂ on Si or on polycrystalline metal electrodes such as Pt or Au or stacks of Pt and Au. As explained above, this freedom can be used to compensate possible disadvantages arising from the non-single-crystalline structure of the first and second dielectric layers.

In contrast, the teaching of US 2006/0118843 A1 limits the choice of a substrate. For instance, an epitaxial growth of BST on Si is extremely difficult or even impossible even with the a seed layer, since Si crystallizes in a diamond lattice with a much larger lattice constant of 5.34 A, compared to BST, which crystallizes in a perovskite lattice with a lattice constant of 3.90-3.99A, dependent on the composition. Furthermore, there is a high chance that during deposition of the oxidic seed layer and the BST layer amorphous SiO₂ will be formed on top of a Si single crystal substrate. This will also prevent the growth of epitaxial layers. In contrast, the ferroelectric varactor of the invention is suitable for use with Si substrates and can be integrated into the highly developed processing technology for integrated circuits.

Furthermore, the use of non-single-crystalline dielectric layers often does not require high fabricating temperatures as they are required for single-crystalline layers of the same material, especially for interesting dielectric materials such as BST or PLZT. Fabricating the dielectric-layer stack becomes possible under processing conditions, which are compatible with standard silicon-based device processing technology. As will be explained in more detail below, preferred embodiments of the ferroelectric varactor therefore have a silicon substrate. Thus, the present invention makes it possible to integrate a ferroelectric varactor with a high tunability, low loss, small hysteresis and high breakdown strength into ubiquitous silicon-based device processing technology. Electronic components are made possible that have excellent high-frequency properties without requiring much processing complexity, thus reducing the costs of these devices.

From Yan et al., “Ferroelectric properties of (Ba_{0.5}Sr_{0.5})TiO₃/Pb(Zr_{0.52}Ti_{0.48})O₃/(Ba_{0.5}Sr_{0.5})TiO₃ thin films with platinum electrodes”, Applied Physics Letters, Volume 82, Number 24, Pages 4325-4327, 16 Jun. 2003, a nonvolatile ferroelectric random access memory (NVFRAM) structure is known that aims at achieving a low fatigue of a ferroelectric memory cell and still a high polarization with a PZT ferreoelectric layer and Pt electrodes. It is reported that ferroelectric memory cells based on PZT and Pt electrodes show fatigue, due to pinning of oxygen vacancies, which are accumulating at the Pt interface, to ferroelectric domains. To suppress the accumulation of oxygen vacancies at the Pt electrodes and thus to reduce fatigue, Yan et al. propose a stack, where between a 600 nm thick PZT and the Pt top and bottom electrodes 7.5-30 nm thin BST films are provided as absorption layers for oxygen vacancies. The BST layers are randomly oriented. The PZT layer grows with a 111 texture. Yan et al. report that the volume fraction of the BST layers should be as small as possible to achieve a high remnant polarization of the ferroelectric PZT memory cell. Accordingly, the fraction of the dielectric material BST that has the weaker ferroelectric hysteresis is less than 10% of the total volume of the dielectric-layer stack of the memory cell proposed by Yan et al.

This device structure of Yan et al. is not appropriate for high-frequency applications, which form a field of application of a tunable capacitor. In fact, Yan's NVFRAM structure is designed with opposite goals, which are characteristic for memory applications, in contrast to high-frequency applications.

In the following, preferred embodiments of the ferroelectric varactor of the first aspect of the invention will be described. Unless stated otherwise explicitly, the embodiments can be combined with each other. The ferroelectric varactor of the present invention is herein also referred to as varactor, tunable capacitor or capacitor.

In one embodiment, it is the second dielectric material, which, as such, when arranged between two electrodes, exhibits a weaker ferroelectric hysteresis of its polarization under an alternating voltage applied between the electrodes than the first dielectric material as such. That means, the first dielectric layers have a stronger ferroelectric hysteresis.

In another embodiment, one dielectric material, which is preferably the first dielectric material, has a higher dielectric strength than the second dielectric material. The dielectric strength of a material relates to an electrical field strength (the breakdown field strength) that is required to destroy the electrically insulating properties of a material, i.e., at which dielectric breakdown occurs. The dielectric strength is a property of the material as such, independent of a particular geometrical configuration in a device. However, it is noted that the actual breakdown field strength of a dielectric layer does depend on specific parameters such as defects present in the layer, and on the geometrical layer configuration. Preferably thus, the breakdown field strength of the first dielectric layer layers is higher than that of the second dielectric layers. The breakdown field strength is also denoted in short as breakdown field.

Besides the high tuning range a very high breakdown field of up to 1.9 MV/cm can be achieved in this embodiment. This enables the operation of the varactor at higher fields than known pure BST-based tunable capacitors, which show typical breakdown fields of only 0.6-1 MV/cm.

In this embodiment, the dielectric-layer stack containing the first and second dielectric materials enables to achieve a tunable capacitor with high relative permittivity, a high tuning range, low hystersis and a high breakdown field. The combination of these advantages cannot be achieved with any of the known single-dielectric-layer configurations.

Different material compositions can be used for the first and second dielectric materials. In one embodiment, the first dielectric material is PbZrₓTi₁₋ₓO₃ (PZT), 0<x<1, or, particularly, La doped PZT (PLZT), and the second dielectric material is Ba₁₋ₓSrₓTiO₃ (BST), 0<x<1. PZT as the first dielectric material enables the production of high-quality tunable capacitors with known materials and know-how. Especially in an embodiment, in which the substrate is formed by Si, the PZT-BST material combination of the present embodiment provides a good tunability performance with low dielectric losses, high breakdown field and is fabricated with a cost-effective and reliable technique. Note that these latter advantages can also be achieved with another substrate than Si.

In an alternative embodiment, a very high relative permittivity and thus a high tuning range is achieved with a dielectric-layer stack, in which the first dielectric material is (Pb(Mg_{0.33}Nb_{0.67})O₃)₁₋ₓ—(PbTiO₃)ₓ (PMN-PT), 0<x<1, which can but must not comprise La doping, and the second dielectric material is Ba₁₋ₓSrₓTiO₃, 0<x<1. A special feature of this embodiment is that a high tuning range and a temperature coefficient of the capacitance can be achieved. The PbTiO3 content in the PMN-PT film and the strontium content in the BST thin film can be adapted to a particular application for achieving a desired tuning range and temperature coefficient.

In a further alternative embodiment, the first dielectric material is a solid solution of PZT with earth alkaline ions, such as Ca, and the second dielectric material is BST. This embodiment achieves an improvement of the temperature stability of the tunable capacitors.

In an embodiment that forms a further alternative to the mentioned material combinations, the first dielectric material is PZT, and the second dielectric material is MgO or ZrO₂ or TiO₂. Here, non-ferroelectric materials are used for the second dielectric material. Combinations of ferroelectric thin films with non-ferroelectric thin films offer the potential to reduce losses of the capacitors and improve temperature stability.

By doping the first and/or second dielectric material with a donor, such as La or Nb, or with an acceptor, such as Mn or Fe, or with a combination of donors or acceptors the leakage current of the capacitor can be reduced.

As mentioned before, a preferred embodiment has the ferroelectric varactor arranged on top of a silicon substrate, which may also be a Si substrate layer, for instance in a silicon-on-insulator (SOI) substrate. Although the function of a plate varactor itself is not affected by the conductance of the substrate, a high-Ohmic or even an insulating substrate is desirable for a good interconnect and planar varactor performance. The Si substrate layer or the complete Si substrate is therefore preferably either highly resistive or even insulating. The ferroelectric varactor of this embodiment implements the advantages of a high performance in the microwave frequency range and small size, compared to known semiconductor varactors in standard integrated circuits. Therefore, the varactor of this embodiment has the potential to replace dedicated discrete high-performance semiconductors by a ferroelectric varactor that is integrated on a wafer. The specific structure of the ferroelectric varactor of the first aspect of the invention allows a processing temperatures in the temperature interval of 500 to 800° C., which is compatible with semiconductor processing. It should be kept in mind, however, that the ferroelectric varactor can also be processed in other substrates such as alumina with or without a planarization layer, sapphire, MgO, glass.

To further reduce to ferroelectric hysteresis of the dielectric-layer stack, the thicknesses of the individual first and second dielectric layers of the dielectric-layer stack are in one embodiment suitably chosen such that the dielectric material with the weaker ferroelectric hysteresis makes up more than 30%, and in another embodiment, more than 40% of the total volume of the dielectric layer stack. The upper limit is in different embodiments 70%, 80%, 90%, and 95%.

Depending on the specific processing conditions, the non-single-crystalline first and second dielectric materials have an either polycrystalline, columnar-textured polycrystalline, mixture of columnar textured polycrystalline and polycrystalline non-textured or amorphous structure. With these structural properties it is possible to achieve a particularly low hysteresis.

It should be noted that a quasi-epitaxial structure, which may also exhibit a columnar microstructure, is also to be understood as an embodiment of a non-single-crystalline structure. A quasi-epitaxial structure is characterized by columnar grains where the layers of first and second dielectric material grow epitaxially on top of each other. It can also be characterized by columnar grains, where parts of the grains grow epitaxially on the substrate and other parts of the columnar grains are tilted on the substrate.

In one embodiment, the first dielectric layer, which is fabricated first in the processing sequence of the varactor, has a columnar-textured polycrystalline structure. In some embodiments, it also has an oriented crystalline structure, which can be for instance a (111) oriented or a (001) oriented structure. The second dielectric layer, which is preferably the layer with the weaker ferroelectric hysteresis, is preferably grown epitaxially on top of the columnar first dielectric layer. That means, it has the columnar-textured polycrystalline structure of the first dielectric layer, on which it is grown. The dielectric layers of the dielectric-layer stack, which are subsequently deposited, are preferably also grown epitaxially on the respective previous layer. In this way, columns of a dielectric stack extend over the three or more dielectric layers of the dielectric-layer stack.

A specific example has a dielectric-layer stack with an alternating sequence of first and second dielectric materials, which are grown on top of each other. The first dielectric material of this stack is La doped PbZrₓTi₁₋ₓO₃, which is columnar grown, i.e., has a columnar-textured polycrystalline structure, and the second dielectric material is Ba₁₋ₓSrₓTiO₃, 0<x<1, which is epitaxially grown on top of a respective layer of the first dielectric material. Such a stack can also comprise in addition to the columnar regions, small regions, which do show not columnar, epitaxially growth but small polycrystalline regions.

Several choices exist for the electrode materials. As a general guideline, the electrodes should be electrically conductive films with a high conductivity to keep ohmic losses low. Particularly suitable electrode materials are Pt or stacks of Pt and Au. Further examples are Ti/Pt, Ti/Au or combinations of metal electrodes such as Ti/Pt/Au/Pt as well as other metals such as Al, TiW/Al, Cu, Ir, Ir/IrO2.

A Pt electrode is particularly suitable in combination with an adjacent first dielectric layer that is made of PZT or PLZT. Different PLZT layers can be arranged in respective adjacent configuration to the Pt electrodes. This could be combinations of PbTiO₃ and PZT or PLZT, which are grown as first dielectric layer on top of the electrode. This electrode-first-dielectric-layer combination supports a low leakage current density and a high breakdown field of the tunable capacitor.

In a further embodiment, either a barrier layer or a stack of barrier layers is arranged between the substrate and the first electrode. Examples of suitable barrier-layer materials are SiO₂, TiO₂, ZrO₂, Al₂O₃, or LaAlO₃.

In some embodiments, the dielectric layer stack has an extension of between 100 nm and 1 μm in a direction from the first to the second electrode. The individual first and second dielectric layers preferably have an extension of between 10 nm and 100 nm in a direction from the first to the second electrode, keeping in mind the design rule provided by claim 1 for the volume fraction of the material with the weaker ferroelectric hysteresis with respect to the total volume of the dielectric-layer stack.

The thicknesses of two layers of the same material in the dielectric-layer stack, i.e, the first or second dielectric layers, is in some embodiments different. An advantage of this “thickness grading” is that a better solution of diffusing Ti atoms from an adhesion layer at the bottom electrode can be achieved. An illustrative example of a such a dielectric layer stack is a layer sequence of 50 nm PLZT, 30 nmBST, 20 nm PLZT, 30 nm BST, and 50 nm PLZT. Other combinations of layer thicknesses are possible.

In further preferred embodiments, a top electrode is provided as a second electrode on the ferroelectric capacitor. Suitable metals for the top electrode are TiW/Al, TiW(N)/Al, where for all cases pure Al or Al doped with e.g. Si or Cu is applied. Other electrodes such as Ti/Au, Pt or stacks of electrodes such as Pt/Au or other metals can be deposited as a thin film. The metal should have a high conductivity.

The ferroelectric varactor of the invention can take the form of a plate capacitor or, in an alternative embodiment, of a coplanar capacitor.

For plate capacitors, alternatives to the mentioned Si substrates are substrate materials such as glass, Al₂O₃, Al₂O₃ ceramic, Al₂O₃ ceramic with a planarization layer, and single-crystal Al₂O₃, but also other substrates such as Cu foil, or other single crystal substrates such as MgO, ZrO₂ can be applied.

A varactor embodiment of the plate-capacitor type has a common first electrode and a split second electrode, thus forming two capacitors connected with each other via the common first electrode.

Another embodiment of the plate-capacitor type has a second electrode that forms an electrically conductive interconnect layer at the same time. A separate material layer for the second electrode is omitted in this embodiment.

For coplanar capacitors, the dielectric-layer stack is processed directly on top of insulating substrates such as high-resistive Si substrates, or on a barrier layer that is deposited on the substrate. The further processing of the dielectric-layer stack does in some embodiments not differ from that used for the fabrication of plate capacitors. Also in this case, the above-mentioned alternative substrate materials can be used.

As indicated, in some embodiments, a barrier is provided between the substrate and the dielectric layer stack. The barrier can take the form of a single layer, or of a barrier-layer stack. Suitable barrier materials are, e.g. SiO₂, MgO, TiO₂, ZrO₂, Al₂O₃, LaAlO₃, or a combination of these materials.

The preceding embodiments show that the ferroelectric varactor of the present invention achieves high relative dielectric permittivities in the dielectric layers, a high breakdown voltage, a large tuning range at low voltages, and low dielectric losses.

According a second embodiment of the invention, an electronic component is provided that comprises a ferroelectric varactor of the first aspect of the invention or one of its embodiments. It shares the advantages of the ferroelectric varactor of the first aspect of the invention.

The electronic component of the second aspect of the invention can in particular take the form of an integrated circuit that contains a ferroelectric varactor according to the first aspect of the invention. This embodiment has an improved performance over known integrated-circuit devices that employ semiconductor varactors. It achieves a particularly good high-frequency operation without increasing the processing cost.

According to a third aspect of the invention, a method is provided for fabricating a ferroelectric varactor with a dielectric-layer stack between a first and a second electrode. The method comprises a step of fabricating the dielectric-layer stack with an alternating layer sequence of at least three dielectric layers in a series connection in a direction from the first to the second electrode. In the method of the invention, fabricating the dielectric-layer stack comprises:

fabricating at least two first dielectric layers of the dielectric-layer stack with a non-single-crystalline first dielectric material having a first dielectric constant;

fabricating at least one second dielectric layer of the dielectric-layer stack with non-single-crystalline second dielectric material with a second dielectric constant that differs from the first dielectric constant, between two respective first dielectric layers.

One of the first and second materials is fabricated such that the material as such, when hypothetically arranged between two test electrodes, exhibits a stronger ferroelectric hysteresis of its polarization under an alternating voltage applied between the test electrodes than the other of the first and second dielectric materials as such. Fabricating the individual first and second dielectric layers of the dielectric-layer stack with a thicknesses implies that the dielectric material with the weaker ferroelectric hysteresis makes more than 20% of the total volume of the dielectric layer stack.

The method of the third aspect of the invention shares the advantages of the ferroelectric varactor of the first aspect of the invention.

In a preferred embodiment, the dielectric-layer stack is fabricated on top of a Si substrate layer. The first dielectric material is PbZrₓTi₁₋ₓO₃, 0<x<1, which is applied with or without lanthanum doping. PZT with Lanthanum doping is also written as Pb_{1-y}La_{y}ZrₓTi₁₋ₓO₃, 0<x, y<1. The second dielectric material is Ba₁₋ₓSrₓTiO₃, 0<x<1. In this embodiment, the step of fabricating the dielectric-layer stack comprises depositing the dielectric-layer stack on top of a Si substrate with barrier layer and electrode with processing temperatures, which are compatible with known Si processing technology.

Further embodiments are defined in the dependent claims and in the following description of the enclosed drawings.

### BRIEF DESCRIPTION OF THE DRAWINGS

Embodiments of the invention will now be explained in more detail with reference to the drawings in which:

FIG. 1 shows a schematic cross-sectional view of a multilayer ferroelectric varactor of the plate-capacitor type,

FIG. 2 shows a schematic cross-sectional view of a ferroelectric varactor of the coplanar-capacitor type, and

FIG. 3 shows the dependence of the relative dielectric permittivity on a voltage applied between the electrodes of a plate capacitor containing a 250 nm PLZT/BST/PLZT dielectric-layer stack.

FIG. 4 shows a schematic cross-sectional view of a third embodiment of a ferroelectric varactor.

FIG. 5 shows a schematic cross-sectional view of a first variant of the embodiment of FIG. 4.

FIG. 6 shows a schematic cross-sectional view of a second variant of the embodiment of FIG. 4.

FIG. 7 shows a schematic cross-sectional view of a third variant of the embodiment of FIG. 4.

FIG. 8 shows a schematic cross-sectional view of a fourth variant of the embodiment of FIG. 4.

FIG. 9 shows a schematic cross-sectional view of a fifth variant of the embodiment of FIG. 4.

FIG. 10 shows a schematic cross-sectional view of a fourth embodiment of ferroelectric varactor.

FIG. 11 shows a schematic cross-sectional view of a fifth embodiment of ferroelectric varactor.

FIG. 12 shows a schematic cross-sectional view of a variant of the embodiment of FIG. 11.

FIG. 13 shows a schematic cross-sectional view of a further embodiment of a ferroelectric varactor illustrating a columnar-textured crystalline structure of the dielectric-layer stack.

### DETAILED DESCRIPTION OF EMBODIMENTS

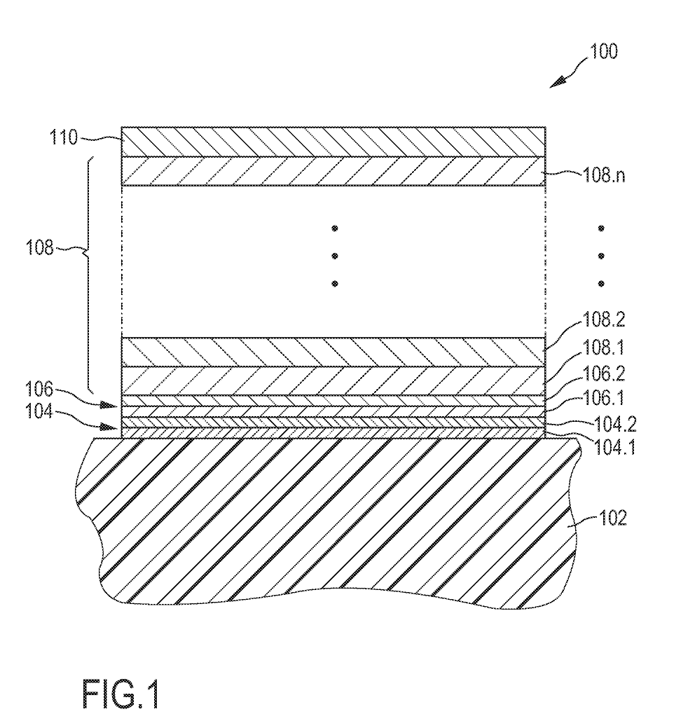

FIG. 1 shows a schematic cross-sectional view of a multilayer ferroelectric varactor of the plate-capacitor type.

The ferroelectric varactor 100 comprises a high-ohmic Si substrate 102 with a barrier-layer structure 104 formed of a SiO₂ layer 104.1 and a TiO₂ barrier layer 104.2. A first electrode 106 is formed by a Ti/Pt electrode with a Ti layer 106.1 and a Pt layer 106.2. Ti/Pt electrodes not only have a high electric conductivity, but also a good adhesion to SiO₂. Alternative electrode materials are Pt, Ti/Au, a Ti/Pt/Au/Pt, Pt/Au/Pt, Ir, or IrO2 or combinations of Pt and Ir or Pt and IrO2 or another metal or metal combination with a high conductivity. This way, low losses of the capacitor at high operation frequencies can be achieved.

Note that the use of the barrier layer 104 is not mandatory. In another embodiment, the first electrode 106 is directly deposited on the insulating substrate such as sapphire. Furthermore, alternative barrier-layer materials can be used, such as MgO, or ZrO₂, Al2O3, LaAlO3, or a combination of these and the previously mentioned oxides.

A dielectric-layer stack 108 is arranged between the first electrode 106 and a second electrode 110. The dielectric-layer stack 108 comprises, in a direction from the first to the second electrode, an alternating layer sequence of La-doped PbZrₓTi₁₋ₓO₃ (0<x<1), herein also referred to in short as PLZT, and BST. For La-doped PbZrₓTi₁₋ₓO₃, x is in some embodiments in the range of 0<x<0.7, and for BaₓSrᵢ,TiO₃ x x in some embodiments is in the range of 0.3<x≦1.0.

The layer sequence starts with a PLZT layer 108.1 and continuous with a BST layer 108.2. This sequence is repeated m times, m≧0, until a top dielectric layer 108.n is reached. That means, the dielectric-layer stack 108 comprises at least three dielectric layers 108.1 to 108.3. It may also comprise 5, 7, 9, and so on, dielectric layers. For the present embodiment, it is assumed that the dielectric-layer stack 108 has a total thickness of approximately 270 nm. In other embodiments, a thickness lower than 270 nm or larger than 270 nm can be applied. The thickness of the individual PLZT and BST layers is approximately 15-20 nm. Layers thicker than 20 nm can be applied in other embodiments, depending on the total thickness of the dielectric-layer stack 108.

The PLZT and BST layers of the dielectric-layer stack 108 are non-single-crystalline. The specific crystalline structure depends on the deposition technique, the processing parameters and the underlying first electrode 106, and the substrate 102, and may be polycrystalline, columnar-textured polycrystalline, quasi-epitaxial, or amorphous. However, an amorphous structure is not preferred. In the present example, the individual dielectric layers are fabricated by a spin-on technique and subsequent annealing. The annealing is performed for each step individually to avoid intermixing Annealing temperatures are in the range between 500° C. and 800° C.

In the dielectric-layer stack 108, the PLZT layers form “first dielectric layers” in the language of the previous description and the claims. The BST layers form “second dielectric layers” in the language of the previous description and of the claims. BST exhibits a weaker ferroelectric hysteresis of its polarization under an alternating voltage, in comparison with PLZT. The hysteresis behavior of the dielectric-layer stack is quite surprising. Even though PLZT is included, which typically has a strong ferroelectric hysteresis, the characteristic hysteresis behavior of PLZT is not observed. The choice of the material combination PLZT/BST also has the advantage of providing a good adhesion between the PLZT layers and the BST layers in the composite. The interfaces between these layers are dense and compact. This avoids problems of delamination during later processing stages.

Depending on the number of repetitions of the PLZT/BST layer pair in the dielectric-layer stack 108, the BST layers make up between 20% and more than 40%, but less than 95%, of the total volume of the dielectric-layer stack. The value of more than 40% holds for the example of a 270 nm total thickness, given a thickness of 15-20 nm of the individual layers. However, it should be noted that the total thickness as well as the individual layer thicknesses may vary in different embodiments. The mutual thicknesses of the PLZT layers and of the BST layers need not be equal. Also two equal layers can be stacked on top of each other to increase the volume fraction of one layer type.

The top electrode 110 is in one embodiment made of Pt. Alternative materials are TiW/Al, TiW(N)/Al, where for the all cases pure Al or Al doped with, e.g., Si or Cu is applied. Also other electrodes such as Ti/Au, Pt or stacks of electrodes such as Pt/Au or other metals can be deposited. Again, a high electrical conductivity of the top electrode is advantageous for keeping losses of the capacitor low at high operation frequencies.

It should be noted that the arrangement of the PLZT layers 108.1 and 108.n immediately adjacent to the bottom electrode 106 and the top electrode 110, respectively, has proven to exhibit a particularly low leakage current of the capacitors. Furthermore, the PLZT layer 108.1 also acts as a seed layer for the following crystallization of the BST layer 108.2. This tends to reduce the processing temperatures and supports an increase of the grain size of the dielectric layers.

The device structure shown in FIG. 1 has excellent electrical properties. Given the thickness of the dielectric-layer stack 108 of 270 nm and the thickness of the individual layers of 15-20 nm, the relative dielectric permittivity was measured to be approximately 480, and the capacitance density is 15.2 nF/mm². The dielectric loss at an operation frequency f_{osc} of 100 kHz and V_{osc} of approximately 0.05 V is 0.7%. The capacitor breaks down only when reaching an electric field of approximately 1 MV/cm. The tunability is 1.3:1 at 5 V and 2:1 at 10 V.

Therefore, the ferroelectric varactor of FIG. 1 provides a structure that is suitable for integration into well-known silicon processing technology. In comparison with known capacitor structures, the processing temperature during the fabrication of the dielectric-layer stack 108 is reduced. However, the disadvantages that may be observed in other structures when using a low processing temperature, such as a low relative dielectric permittivity, are avoided in the ferroelectric varactor of FIG. 1. This way, the tuning range of the ferroelectric varactor can be kept high, comparable to prior-art MIM structures with a single-crystalline dielectric layer, such as BST, which is fabricated using temperatures of up to 900° C. on substrates as sapphire (Al₂O₃).

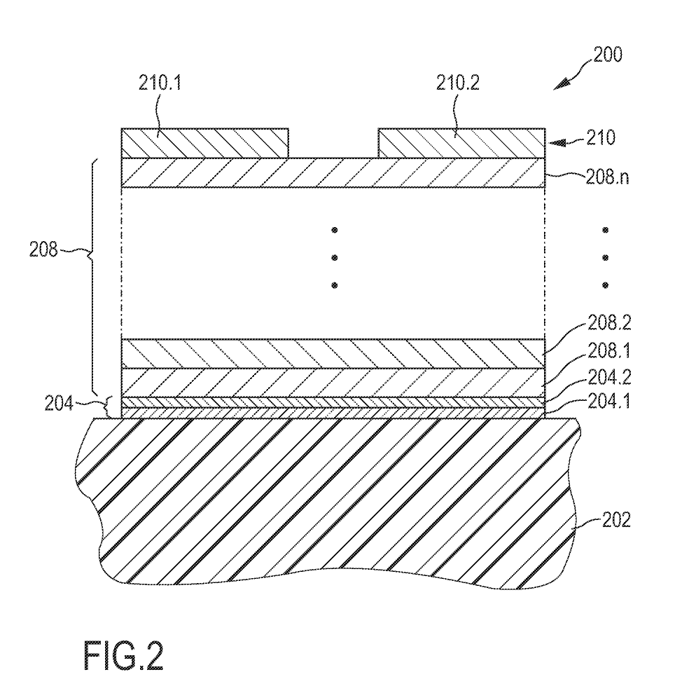

FIG. 2 shows a schematic cross-sectional view of a ferroelectric varactor of the coplanar-capacitor type.

The ferroelectric varactor 200 resembles the ferroelectric varactor 100 of FIG. 1, except for the use of a single electrode layer 210, which is patterned to form a first electrode 210.1 and a second electrode 210.2 according to a desired coplanar capacitor design. The particular electrode pattern can be chosen according to the specific requirements of a particular application. For instance, an interdigital arrangement of the electrodes 210.1 and 210.2 may be chosen. The top electrode is made of Pt, or TiW/Al, or TiW(N)/Al, where for the all cases pure Al, or Al doped with, e.g., Si or Cu is applied. Also other electrodes such as Ti/Au, or stacks of electrodes such as Pt/Au can be applied.

The underlying dielectric-layer stack 208 resembles that of FIG. 1 and is composed of an alternating PLZT/BST/ . . . /PLZT layer sequence. The bottom PLZT layer 208.1 is directly deposited on the barrier-layer structure 204, which is identical to the barrier-layer structure 104 of FIG. 1.

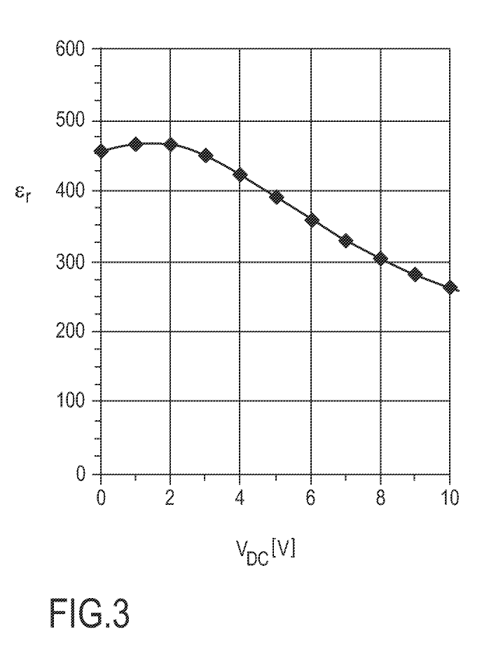

FIG. 3 shows the dependence of the relative dielectric permittivity on a voltage applied between the electrodes of a plate capacitor containing a 270 nm PLZT/BST/PLZT dielectric-layer stack. The diagram was obtained from a ferroelectric varactor with a 270 nm thick dielectric layer stack comprising an alternating PLZT/BST/ . . . /PLZT layer sequence on a Ti/Pt electrode separated from a high-ohmic Si layer by a SiO₂/TiO₂ barrier. The individual layers of the dielectric-layer stack were annealed at a temperature of 700-760° C. for 1-5 minutes The measurement was performed at a voltage having an alternating component of 0.05 V, alternating at a frequency of 1000 kHz, and with a DC component indicated on the abscissa of the diagram of FIG. 3. As is clearly observed from the measured dielectric permittivities at different DC voltages V_{DC}, the relative dielectric permittivity ∈ᵣ changes from a value of 460 at 0 V to a value of 370 at 5 V, which corresponds with a field of 20 V/um, and further decreases to a value of 250 at 10 V, which corresponds with 40 V/um. The observed tunability is 1.2:1 at 5 V (20 V/um) and approximately 1.8:1 at 10 V (40 V/um). For comparison, BST layer results in a tunability of only 1.3:1 at a DC field of 40 V/um.

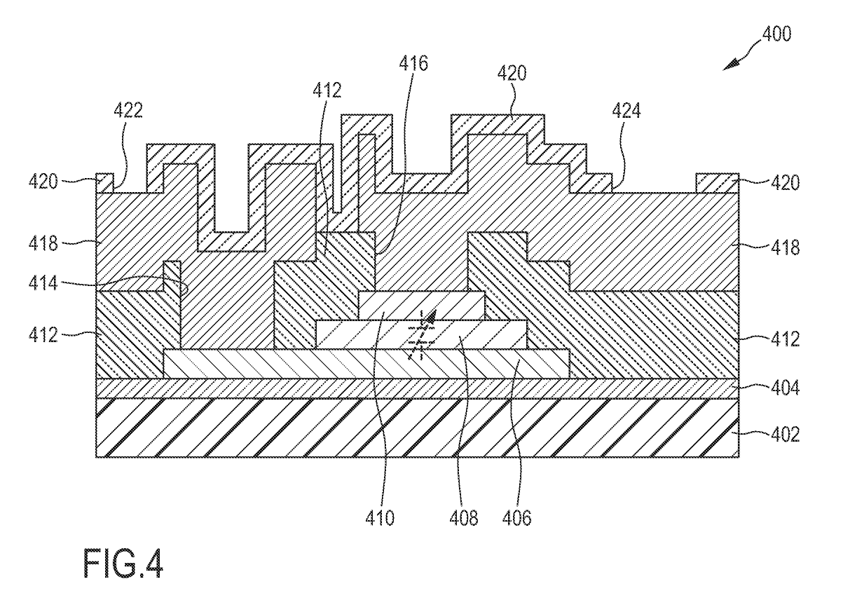

FIG. 4 shows a schematic cross-sectional view of a third embodiment of a ferroelectric varactor 400.

The ferroelectric varactor 400 has a substrate 402. Examples of suitable substrate materials for the substrate 402 are Si, or MgO, or sapphire, or glass. On top of the substrate 402, a barrier layer 404 is deposited. Examples of suitable barrier-layer materials are SiO₂, SiO₂+TiO₂, SiO₂+ZrO₂, SiO₂+Al₂O₃. The barrier layer 404 can be deposited using standard thin-film processes, such as sputtering or evaporation. However, any other suitable technique can be applied. A bottom electrode 406 is deposited on top of the barrier layer 404. Examples of suitable bottom-electrode materials are Pt, Ti/Pt, Pt/Au/Pt, Ti/Pt/Au/Pt, or other conductive electrode materials.

The barrier layer 404 is optional. In other embodiments, the bottom electrode is directly deposited on the substrate 402.

On top of the bottom electrode, a tunable dielectric layer 408 is deposited. The fine structure of the tunable dielectric layer 408 is not shown in this schematic Figure. The tunable dielectric layer 408 is formed of a dielectric-layer stack that comprises an alternating layer sequence of at least three dielectric layers in a series connection. For instance, a PLZT/BST/ . . . /PLZT layer sequence is suitable. The lateral extension and shape of the dielectric layer stack can be patterned by reactive ion etching (RIE) or by wet etching.

A second or top electrode 410 is provided on top of the dielectric-layer stack 408. Suitable materials for the top electrode are Pt, Pt/Au, Pt/Au/Pt, or TiW/Al. The lateral extension and shape of the top electrode 410 is patterned with standard lithographic processes such as wet or dry etching techniques.

Note that the patterning sequence is performed after the deposition of the top electrode 410 for the present embodiment. Therefore, during the patterning, the top electrode 410 is patterned first. Subsequently, the dielectric-layer stack 408 is patterned. After that, the bottom electrode 406 is patterned. Standard etching techniques such as reactive ion etching are suitable patterning techniques for the bottom electrode is.

On top of the layer stack of the ferroelectric varactor 400 described in the previous paragraphs, an encapsulation layer 412 is deposited. The encapsulation layer can comprise SiN or SiO₂, or TiO₂+SiN, or SiO₂+SiN, or Al₂O₃+SiN, or PZT+SiN, or PLZT+SiN, where the sign “+” indicates that the materials on both sides of the “+” are present in the encapsulation layer. The encapsulation layer 412 can be deposited by standard techniques such as chemical vapor deposition (CVD), sputtering, or sol-gel deposition. The encapsulation layer 412 is patterned after deposition by wet or dry etching techniques or a combination of both techniques, to provide openings 414 and 416 for contacts to the bottom electrode 406 and the top electrode 410, respectively.

On top of the encapsulation layer 412 and in the contact openings 414 and 416, a highly conductive interconnect layer 418 is deposited. Examples of suitable interconnect-layer materials are TiW/Al, TiW(N)/Al, TiN/Al, Ti/Au, TiW(N)/Au, TiN/Au, NiCr/Au, Ti/Ag, TiN/Au or Ti/Cu. Other highly conductive electrode materials may be used as well. The interconnect layer can be deposited for instance by sputtering or evaporation. The interconnect layer 418 is then patterned by wet or dry etching.

In one embodiment, the contact opening 414, which is filled with the interconnect-layer material 418, extends on three lateral sides of the top-electrode contact opening 416, for instance in a U-shape. This way, the series resistance of the bottom electrode can be minimized.

On top of the interconnect layer 418, a cover layer 420 is deposited. Suitable cover-layer materials are inorganic materials such as SiN or SiO₂, organic materials, or a combination of organic and inorganic materials. The cover layer 420 is patterned by conventional wet or dry etching techniques to provide contact openings 422 and 424. Contacts (not shown) can be applied by wire-bonding or flip-chip mounting.

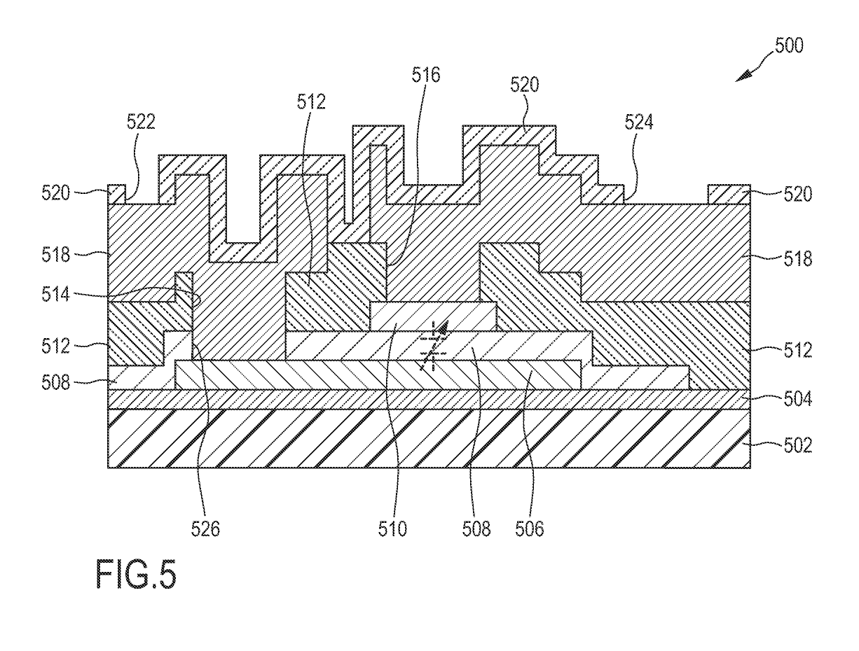

FIG. 5 shows a schematic cross-sectional view of a ferroelectric varactor 500 that forms a first variant of the embodiment of FIG. 4.

The ferroelectric varactor 500 of FIG. 5 resembles the ferroelectric varactor 400 of FIG. 4 in many structural elements. The following description will focus on important structural differences. Corresponding structural elements of the ferroelectric varactors 400 and 500 are denoted by reference labels that differ only in the first digit. For instance, the encapsulation layer 412 of the ferroelectric varactor of FIG. 4 is denoted with the reference label 512 in FIG. 5 representing the ferroelectric varactor of FIG. 5.

The ferroelectric varactor 500 has a dielectric-layer stack 508 that not only extends on the bottom electrode 506, but also on the barrier layer 504. This results in the fact, that the bottom electrode is patterned first with standard lithographic processing techniques. After this the ferroelectric layer stack is deposited over the full bottom electrode. This can improve the adhesion of the bottom electrode and prevent delaminations of the bottom electrode during ferroelectric layer etching along the flow given in FIG. 4. The processing of the ferroelectric varactor 500 involves in one embodiment a patterning of the bottom electrode 506 directly after its deposition. This allows the subsequent deposition of the tunable dielectric-layer stack on top of both, the barrier layer 504 and the bottom electrode 506. After this, the top electrode 510 is deposited and patterned with standard patterning techniques. After the patterning of the top electrode 510, the dielectric-layer stack 506 is laterally patterned by wet or dry etching techniques, thus realizing a contact opening 526 in the dielectric-layer stack 508. In the same step, the material of the dielectric-layer stack is removed in areas of the wafer, where transmission lines or coils are to be fabricated later on, for instance making use of the highly conductive interconnect layer 518.

The subsequent processing involves the deposition and patterning of the encapsulation layer 512 and further processing steps, which correspond to those described in the context of the embodiment of FIG. 4.

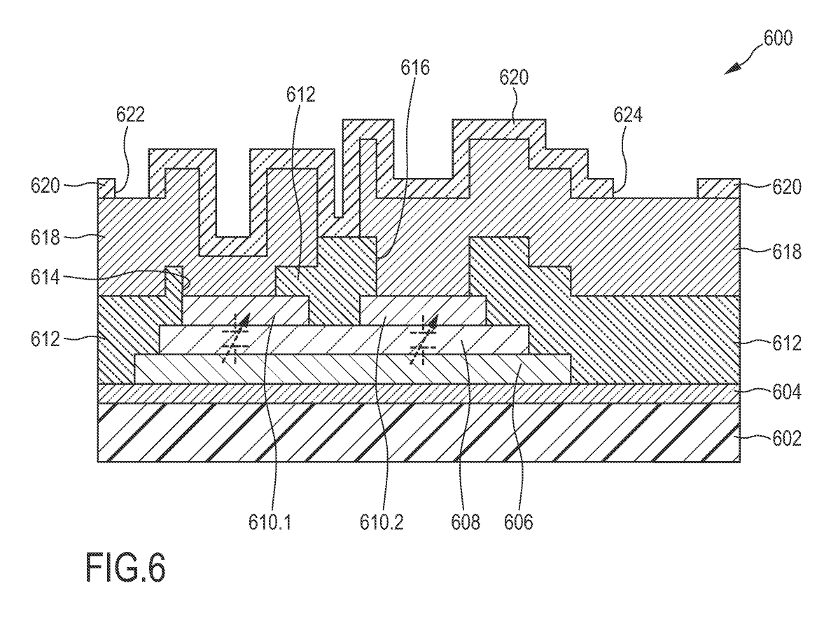

FIG. 6 shows a schematic cross-sectional view of a ferroelectric varactor 600 that forms a second variant of the ferroelectric varactor 400. The following description will again focus on the structural differences. Corresponding structural elements of the ferroelectric varactors 400 and 600 are again denoted by reference labels that differ only in the first digit. For instance, the encapsulation layer 412 of the ferroelectric varactor of FIG. 4 is denoted with the reference label 612 in the ferroelectric varactor of FIG. 6.

The ferroelectric varactor 600 of FIG. 6 contains two individual capacitors. This is achieved by patterning the top-electrode layer to form two separate electrodes 610.1 and 610.2, which are electrically isolated from each other by the encapsulation layer 612. Two capacitors are thus connected in series by the common bottom electrode 606. The varactor is contacted with external devices via the first and second top electrodes 610.1 and 610.2.

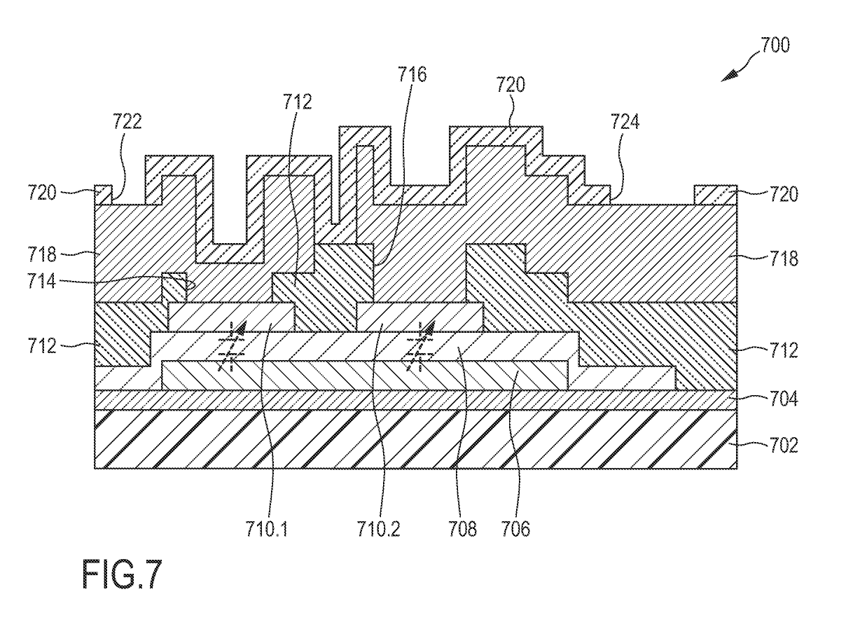

FIG. 7 shows a schematic cross-sectional view of a ferroelectric varactor 700 that forms a third variant of the embodiment of FIG. 5. The description will again focus on the structural differences. As before, like structural elements of the ferroelectric varactors 500 and 700 are denoted by reference labels that differ only in the first digit.

The ferroelectric varactor 700 of FIG. 7 contains two individual capacitors, which is achieved by patterning the top-electrode layer to form two separate electrodes 710.1 and 710.2. The electrodes 710.1 and 710.2 are electrically isolated from each other by the encapsulation layer 712. Two capacitors are thus connected in series by the common bottom electrode 706. A contact of the varactor 700 with external devices is established via the first and second top electrodes 710.1 and 710.2. The present variant thus forms a combination of the characteristic features of FIGS. 5 and 6.

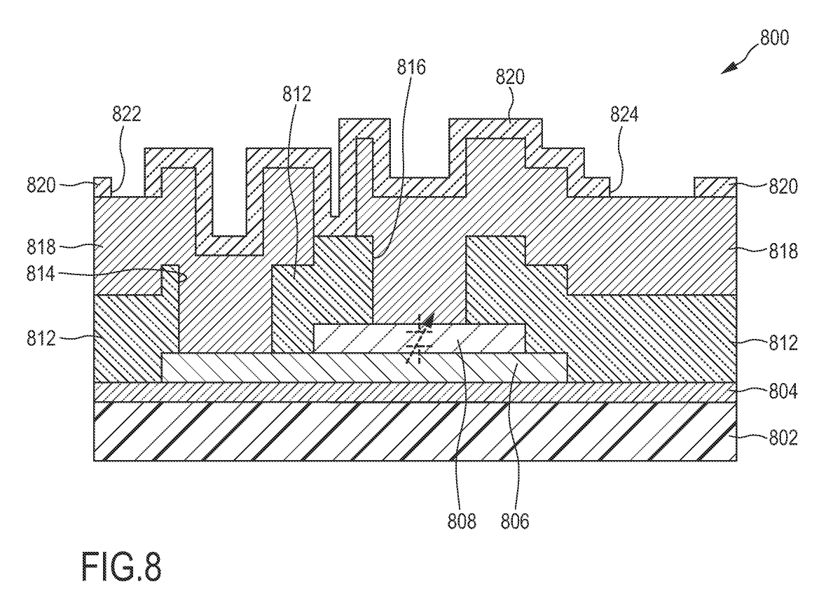

FIG. 8 shows a schematic cross-sectional view of a ferroelectric varactor 800 that forms a fourth variant of the embodiment of FIG. 4. As before, the present description will focus on structural differences between the varactors 400 and 800. Like structural elements of the ferroelectric varactors 400 and 800 are thus denoted by reference labels that differ only in the first digit.

The ferroelectric varactor 800 of FIG. 8 differs from the previous embodiments in that the interconnect layer 818 at the same time functions as a top electrode of the capacitor. No separate top-electrode is used in the present embodiment, which is to be compared with the top electrode 410 that is present in the ferroelectric varactor 400 of FIG. 4.

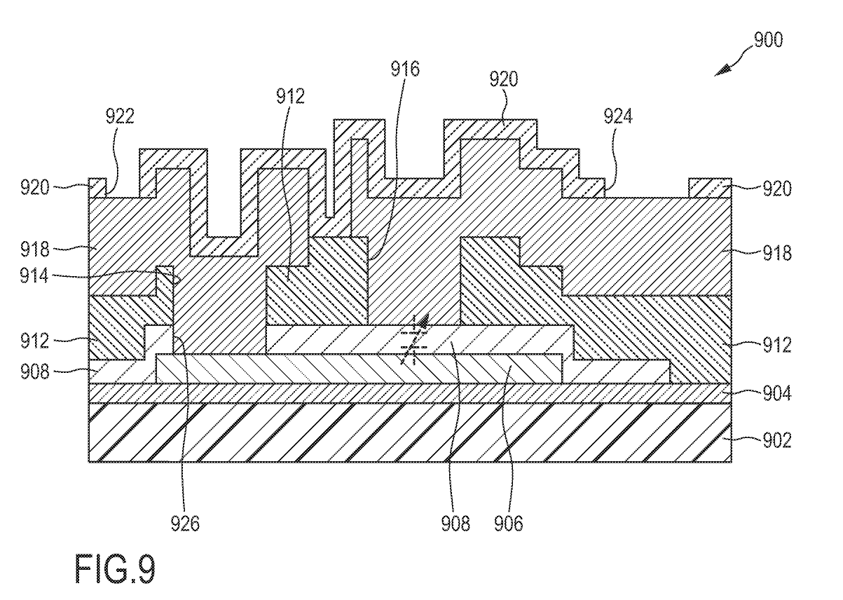

FIG. 9 shows a schematic cross-sectional view of a ferroelectric varactor 900 that forms a fifth variant of the embodiment of FIG. 4. The present description will again focus on the structural differences between the two varactors. Like structural elements of the ferroelectric varactors 400 and 900 are again denoted by reference labels that differ only in the first digit.

The ferroelectric varactor 900 combines the specific features of the ferroelectric varactors 500 of FIGS. 5 and 800 of FIG. 8. It thus has a dielectric-layer stack 908 that not only extends on the bottom electrode 906, but also on the barrier layer 904. In the ferroelectric varactor 900 of FIG. 9 the interconnect layer 918 at the same time functions as a top electrode of the capacitor.

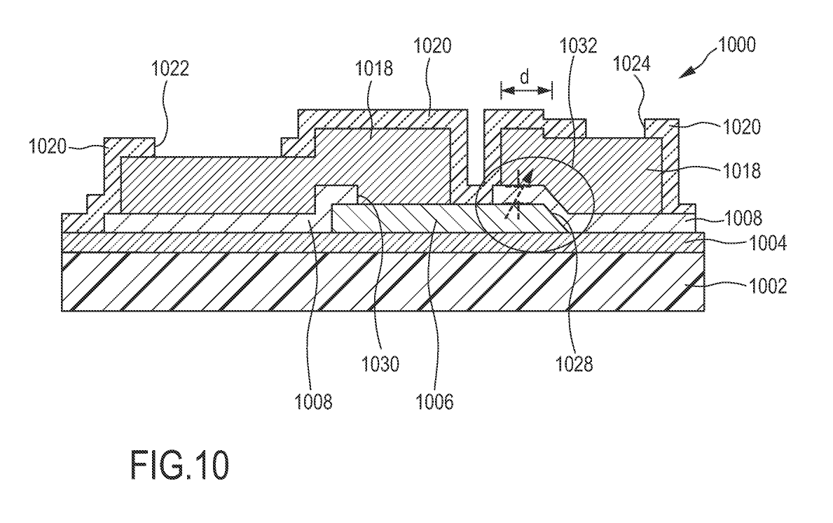

FIG. 10 shows a schematic cross-sectional view of a ferroelectric varactor 1000 that forms a fourth illustrative embodiment.

The ferroelectric varactor 1000 has a substrate 1002. Substrate materials suitable for the present embodiment correspond to those mentioned in the context of the description of the ferroelectric varactor 400 of FIG. 4.

A barrier layer 1004 is deposited on top of the substrate 1002. For suitable barrier-layer materials, references also made to the description of the barrier-layer 404 in the context of the description of the ferroelectric varactor 400 of FIG. 4.

On top of the barrier-layer 1004, or, in an alternative embodiment, directly on top of the substrate 1002, a bottom electrode 1006 is deposited. Suitable bottom-electrode materials are described in the before-mentioned context of FIG. 4.

The bottom electrode 1006 is patterned after its deposition by standard lithographic techniques and by dry etching techniques. Note that this processing leads to a sloping lateral edge 1028. An active region that contains the electrodes of the capacitor is marked by an ellipse 1032 in FIG. 10.

On top of the substrate patterned in this way, a tunable dielectric-layer stack 1008 is deposited. Examples of suitable dielectric-layer stacks have been described elsewhere within the present application. The dielectic-layer stack 1008 is subsequently patterned by wet or dry etching techniques. Here, as an alternative design in comparison with previous embodiments, the dielectric-layer stack 1008 is etched away in regions, where conductive lines or coils are formed after later processing steps. Thus, an opening 1030 is for instance formed in the dielectric-layer stack 1008. A lateral extension d of an active dielectric layer section of the dielectric-layer stack 1008 is between 2 and 30 μm.

During processing of the ferroelectric varactor 1000, a top electrode in the form of a highly conductive metal layer 1028 is deposited on the dielectric-layer stack 1008 and in its opening 1030. This top electrode is patterned by standard lithographic techniques and by wet or dry etching processes. Suitable materials for the top electrode have been mentioned in the context of the description of the highly conductive layer 418 of the ferroelectric varactor 400 of FIG. 4.

Subsequently, a cover layer 1020 is deposited and patterned to provide openings 1022 and 1024 for contacting.

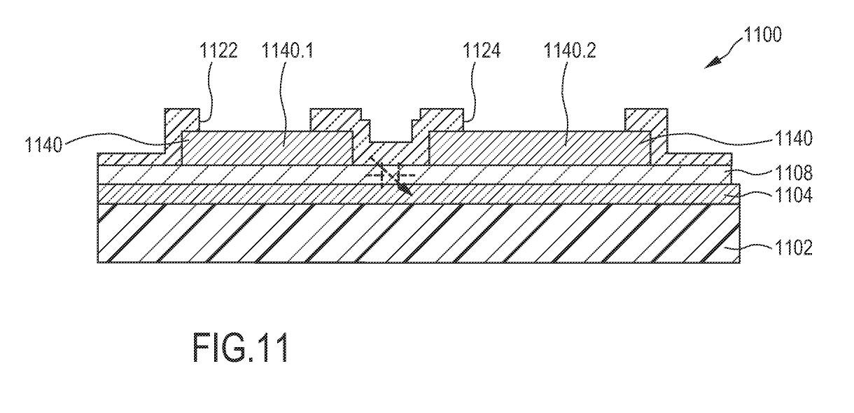

FIG. 11 shows a schematic cross-sectional view of a ferroelectric varactor 1100 that forms a fifth illustrative embodiment. The ferroelectric varactor 1100 has a substrate 1102. Substrate materials suitable for the present embodiment correspond to those mentioned in the context of the description of the ferroelectric varactor 400 of FIG. 4.

A barrier layer 1104 is deposited on top of the substrate 1102. For suitable barrier-layer materials, references also made to the description of the barrier-layer 404 in the context of the description of the ferroelectric varactor 400 of FIG. 4.

On top of the barrier-layer 1104, or, in an alternative embodiment, directly on top of the substrate 1102 a tunable dielectric-layer stack 1108 is deposited. Examples of suitable dielectric-layer stacks have been described elsewhere within the present application. The dielectic-layer stack 1108 is subsequently patterned by wet or dry etching techniques. The dielectric-layer stack 1108 is etched away in regions, where after later processing steps, conductive lines or coils are processed. Thus, an opening 1130 is for instance formed in the dielectric-layer stack 1108.

On top of the dielectric-layer stack 1108, an electrode layer 1140 is deposited. The electrode layer 1140 is made from a highly conductive metal such as thick Pt or Pt/Au or Pt/Au/Pt, TiW/Al, TiW(N)/Al, TiN/Al, Ti/Au, TiW(N)/Au, TiN/Au, NiCr/Au, Ti/Ag, TiN/Au, or Ti/Cu, or any other highly conductive metal. The electrode layer 1140 is subsequently patterned by standard lithographic techniques and wet or dry etching processes to obtain a first electrode 1140.1 and a second electrode 1140.2.

After this, a cover layer 1120 is deposited. Suitable cover-layer materials are mentioned in the context of the description of cover-layer 420 of the ferroelectric varactor 400 of FIG. 4. The cover-layer is then patterned by conventional wet or dry etching techniques, to provide contact openings 1122 and 1124 for applying contacts by wire-bonding or flip-chip mounting.

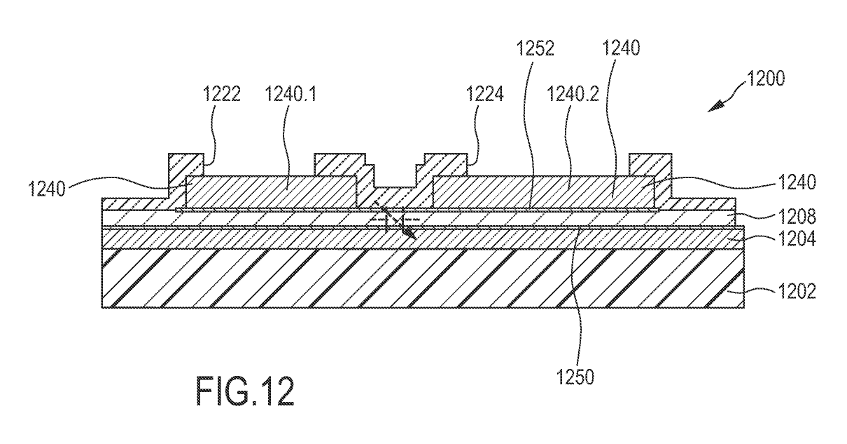

FIG. 12 shows a schematic cross-sectional view of a ferroelectric varactor 1200 that forms variant of the embodiment of FIG. 11.

In the present variant, the ferroelectric varactor 1200 has additional, poorly conductive electrode layers 1250 and 1252 on both sides of the dielectric-layer stack 1208. A lower electrode layer 1250 is arranged between the layer 1204 and the dielectric-layer stack 1208, or, alternatively, between the substrate 1202 and the dielectric-layer stack 1208 if the optional barrier layer 1204 is omitted. An upper electrode layer 1252 is arranged between the dielectric-layer stack 1208 and the top-electrode layer 1240. The electrode layers 1250 and 1252 can for instance be made of RuO₂, SrRuO₃, SiCrO, SiCrN, or conductive ZnO or complex conductive layers such as semiconductive BaTiO₃, SrTiO₃, or any other conductive or semiconduting metal oxides or metal nitrides or another poorly conductive layer.

During operation of this coplanar capacitor design, the poorly conductive electrode layers 1250 and 1252 are connected to a DC voltage supply for tuning The highly conductive first and second electrode 1240.1 and 1240.2, respectively, are connected to a RF signal. This embodiment enables a tunable capacitor with a high tuning range and a low distortion.

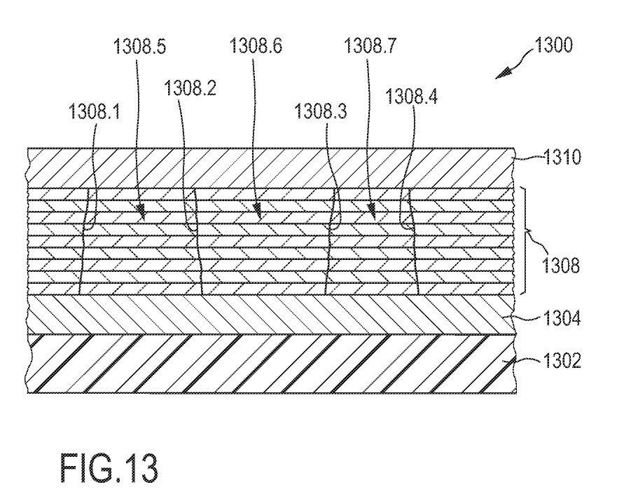

FIG. 13 shows a schematic cross sectional view of a ferroelectric varactor 1300. The varactor 1300 has a Si substrate 1302, a bottom electrode 1304, a dielectric-layer stack 1308, and a top electrode 1310. FIG. 13 serves to illustrate a columnar-textured crystal structure of the dielectric-layer stack 1308, which in the present illustrative example contains an alternating sequence of nine dielectric layers, the material choices having been described before. The columnar structure is indicated by edges 1308.1 to 1308.4 between columns 1308.5 to 1308.7. In the columns, the first and second dielectric layers are epitaxially grown on top of each other. This structure can for instance be made visible in dark field transmission electron microscopy (TEM) images, wherein bright regions show columns in proper diffraction condition and dark regions show columns not in diffraction. The contrast between dark and bright regions observed in such images is not shown here for increasing the clarity of graphical representation. In addition, the layer stack can be made visible in the cross section with scanning transmission electronic microscopy in the high angle angular dark field mode (STEM-HAADF).

The cross section of the columns has approximately the shape blocks with nearly straight lines vertically through the tunable layer stack from the bottom to the top electrodes. Laterally neighboring columns have an alternating arrangement of longer and shorter lengths. That means that the columns are arranged in an alternating sequence along the lateral direction of the electrode shown in the Figure, such that no gaps are observed between the columns. The columns show in the horizontal direction lengths of 100-300 nm. In the layer stack there are also some small round regions without columnar growth visible.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

Any reference signs in the claims should not be construed as limiting the scope.

1. A ferroelectric varactor, comprising:
a first and a second electrically conductive electrode, and
a dielectric-layer stack between the first and second electrodes, wherein
the dielectric-layer stack comprises an alternating layer sequence of at least three dielectric layers in a series connection,
at least two non-single-crystalline first dielectric layers of the dielectric-layer stack are made of a first dielectric material having a first dielectric constant,
at least one non-single-crystalline second dielectric layer of the dielectric-layer stack is arranged between two respective first dielectric layers and made of a second dielectric material with a second dielectric constant that differs from the first dielectric constant,
wherein one of the first and second dielectric materials arranged between two test electrodes exhibits a weaker ferroelectric hysteresis of its polarization under an alternating voltage applied between the test electrodes than the other of the first and second dielectric materials as stfell, and wherein
extensions of the first and second dielectric layers of the dielectric-layer stack in a direction perpendicular to their respective layer planes are such that the first or second dielectric material with the weaker ferroelectric hysteresis makes up more than 20% of the total volume of the dielectric-layer stack.

2. The ferroelectric varactor of claim 1, wherein the first dielectric material has a higher dielectric strength than the second dielectric material.

3. The ferroelectric varactor of claim 1, wherein the first dielectric material is PbZrₓTi₁₋ₓO₃, 0<x<1, or La doped PbZrₓTi₁₋ₓO₃ and the second dielectric material is Ba₁₋ₓSrₓTiO₃, 0<x<1.

4. The ferroelectric varactor of claim 1, wherein the first dielectric material is (Pb(Mg_{0.33}Nb_{0.67})O₃)₁₋ₓ—(PbTiO₃)ₓ, 0<x<1, with or without La doping, and the second dielectric material is Ba₁₋ₓSrₓTiO₃, 0<x<1.

5. The ferroelectric varactor of claim 1, wherein the first dielectric material is a solid solution of either PbZrₓTi₁₋ₓO₃, 0<x<1, or La-doped PbZrₓTi₁₋ₓO₃, and of earth alkaline ions, and wherein the second dielectric material is Ba₁₋ₓSrₓTiO₃, 0<x<1.

6. The ferroelectric varactor of claim 1, wherein the first dielectric material is PbZrₓTi₁₋ₓO₃, 0<x<1, or La doped PbZrₓTi₁₋ₓO₃ and the second dielectric material is MgO or ZrO₂ or TiO₂.

7. The ferroelectric varactor of claim 1, wherein the first or second dielectric material additionally contains La, Nb, Mn or Fe dopants.

8. The ferroelectric varactor of claim 1, which is arranged on top of an either highly resistive or insulating Si substrate layer.

9. The ferroelectric varactor of claim 1, wherein the thicknesses of the individual first and second dielectric layers of the dielectric-layer stack are suitably chosen such that the dielectric material with the weaker ferroelectric hysteresis makes up more than 20% of the total volume of the dielectric layer stack.

10. The ferroelectric varactor of claim 1, wherein the first and second dielectric materials have a columnar-textured polycrystalline structure.

11. The ferroelectric varactor of claim 1, wherein the first electrode, the second electrode or the first and second electrodes are made of Pt,Ti/Pt,TiO₂/Pt, Ti/Au, or Au or a stack of Pt and Au or of Ti/Pt and Au.

12. The ferroelectric varactor of claim 1, wherein either a barrier layer or a stack of barrier layers is arranged between a substrate layer and the first electrode.

13. The ferroelectric varactor of claim 1, wherein the dielectric-layer stack has an extension of between 100 nanometer and 1 micrometer in a direction from the first to the second electrode.

14. The ferroelectric varactor of claim 1, wherein the individual first and second dielectric layers have an extension of between 1 nanometer and 100 nanometer in a direction from the first to the second electrode.

15. The ferroelectric varactor of claim 1, which takes the form of a plate capacitor.

16. The ferroelectric varactor of claim 1, which takes the form of a coplanar capacitor.

17. (canceled)

18. A method for fabricating a ferroelectric varactor with a dielectric-layer stack between a first and a second electrode, comprising:
fabricating the dielectric-layer stack with an alternating layer sequence of at least three dielectric layers in a series connection in a direction from first to the second electrode;
wherein fabricating the dielectric-layer stack comprises:
fabricating at least two non-single-crystalline first dielectric layers of the dielectric-layer stack with a first dielectric material having a first dielectric constant;
fabricating at least one non-single-crystalline second dielectric layer of the dielectric-layer stack with a second dielectric material having a second dielectric constant that differs from the first dielectric constant, between two respective first dielectric layers,
wherein one of the first and second dielectric materials is fabricated such that the material when arranged between two test electrodes, exhibits a stronger ferroelectric hysteresis of its polarization under an alternating voltage applied between the test electrodes than the other of the first and second dielectric materials; and
fabricating the individual first and second dielectric layers of the dielectric-layer stack with a thicknesses such that the dielectric material with the weaker ferroelectric hysteresis makes up more than 20% of the total volume of the dielectric layer stack.

19. The method of claim 18, wherein the dielectric-layer stack fabricated on top of a Si substrate layer, wherein the first dielectric material is PbZrₓTi₁₋ₓO₃, 0<x<1, either with or without La doping, and the second dielectric material is Ba₁₋ₓSrₓTiO₃, 0<x<1, and wherein fabricating the dielectric-layer stack comprises depositing the dielectric-layer stack on top of the Si substrate layer with a barrier layer or a stack of barrier layers and with out electrode within a temperature interval of between 500° C. and 800° C.
